(19) United States
(12) Patent Application Publication
(10) Pub. No.: US 2024/0249140 A1
(43) Pub. Date: Jul. 25, 2024

(54) SIMULATED ANNEALING BASED INTEGERIZATION OF HIDDEN WEIGHTS FOR AREA-EFFICIENT IOT EDGE INTELLIGENCE

(71) Applicant: UNIVERSITY OF SOUTH FLORIDA, Tampa, FL (US)

(72) Inventor: Srinivas Katkoori, Wesley Chapel, FL (US)

(21) Appl. No.: 18/419,362

(22) Filed: Jan. 22, 2024

Related U.S. Application Data
(60) Provisional application No. 63/612,936, filed on Dec. 20, 2023.
(60) Provisional application No. 63/480,817, filed on Jan. 20, 2023.

(51) Int. Cl. G06N 3/08

(52) U.S. Cl. CPC G06N 3/08

(57) ABSTRACT

Methods and systems for hardware optimization of a neural network model are disclosed. The methods and systems include: obtaining a trained neural network model, the trained neural network model comprising a plurality of neurons, the plurality of neurons comprising a plurality of neuron layers and a plurality of neuron weights; performing a simulated annealing process for the plurality of neuron weights; generate a plurality of new weights for one of the plurality of neuron layers; retrain the trained neural network model using the plurality of new weights; obtaining an updated plurality of neuron weights; obtaining an optimized neural network model using the updated plurality of neuron weights; and generating an optimized circuit layout for hardware that implements the optimized neural network model obtained using the updated plurality of neuron weights. Other aspects, embodiments, and features are also claimed and described.

### CROSS-REFERENCE TO RELATED APPLICATION(S)

This application claims priority to U.S. Provisional Patent Application Serial Nos. 63/480,817 filed Jan. 20, 2023, and 63/612,936 filed Dec. 20, 2023, the contents of each are hereby incorporated by reference in their entireties.

### STATEMENT REGARDING FEDERALLY SPONSORED RESEARCH

N/A

### BACKGROUND

Deep Neural Networks' success has been largely attributed to the construction of highly complex larger neural networks (NNs). The high parameterization of NNs results in extremely accurate models. This enables the models to perform more effectively and accurately across a range of applications, such as image classification, object detection, etc. However, this also significantly raises the computational cost, memory requirements, and power demands involved in use of the use of NNs, which is very disadvantageous in applications where efficient resource utilization is important. The high computational costs and memory requirements of Highly parameterized NN models have made their adoption and distribution more difficult in resource constrained devices and applications. Larger NN models also have a larger run time and necessitate an increased amount of hardware resources.

One way that applications having or resource-limitations have attempted to implement NNs is by use of specialized, NN-specific chips (whether ASIC chips, FPGA, etc.) that can more efficiently process a given NN model instead of needing a more powerful general purpose CPU or GPU. However, the high parameterization of NNs means this NN-specific chips wind up being highly complex and having a high number of gates/transistors—this leads to both higher cost of manufacturing for the chips as well as higher power demands. Thus, these chips are not an advantageous solution for most cost and resource constrained applications.

As the demand for an efficient NN hardware model increases, research and development continue to advance to create a NN device that meets requirements such as portability, computationally light-weight, small memory footprint and/or chip size, and low power. Described herein are simulated annealing based neural network optimization methodologies which may be used to build an energy-efficient, lightweight, and compressed neural network hardware model for resource-constrained environments. In some examples, micro-architectural parameters (neuron weights) may be fine-tuned in a hidden layer of multilayer perceptron hardware.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a device including an electronic processor having a set of input pins, a set of output pins, and a layout of circuit gates. The layout of circuit of circuit gate can implement an optimized neural network model. The optimized neural network model can be obtained by performing a simulated annealing process of a plurality of neuron weights in a trained neural network model. The layout can cause the electronic process to extract a plurality of features from the runtime dataset when receiving a runtime dataset via the set of input pins. The plurality of features can be applied to the optimized neural network model to obtain a confidence level. A prediction indication can be outputted based on the confidence level via the output pins.

In further aspects, the present disclosure can provide a method for hardware optimization. A trained neural network model can be obtained. The trained neural network model can include a plurality of neurons. The plurality of neurons can include a plurality of neuron layers and a plurality of neuron weights. A simulated annealing process can be performed for the plurality of neuron weights. A plurality of new weights for one of the plurality of neuron layers can be generated and the trained neural network model can be retrained using the plurality of new weights. An updated plurality of neuron weights can be obtained, and an optimized neural network model can be obtained using the updated plurality of neuron weights. An optimized circuit layout can be generated for hardware that can implement the optimized neural network model obtained using the updated plurality of neuron weights.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 illustrates an example of multilayer perceptron.

FIG. 2 illustrates an example representation of a hardware optimization process according to some embodiments.

FIG. 3 is a block diagram conceptually illustrating a system for hardware optimization of neural networks according to some embodiments.

FIG. 4 is a flowchart illustrating an example hardware optimization process for a neural network model.

FIG. 5 is a flowchart illustrating a process for manufacturing a chip based on an optimized circuit layout.

FIG. 6 is a flowchart illustrating an example embodiment of another process for optimization of a neural network.

FIG. 7 illustrates five bar graphs for comparing saving between circuit layouts, according to some embodiments.

FIG. 8 illustrates five bar graphs for comparing savings between circuit layouts, according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

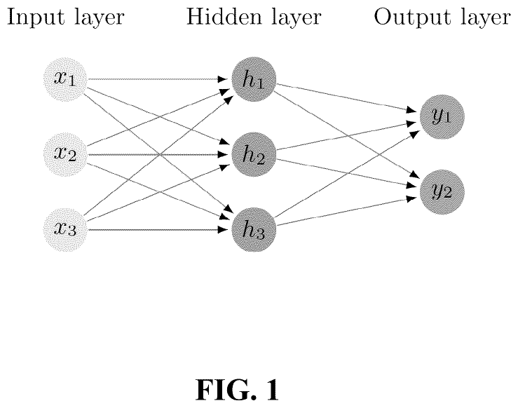

Neural networks mimic the activity of the human brain, enabling AI, machine learning, and deep learning systems to spot patterns and solve common issues. These networks, as known as “artificial neural networks” are subfields of machine learning. These networks have nodes that are interconnected and arranged in layers. At a very general level, they can be thought of as having various combinations of three types of layers: an input layer, single or multiple hidden layers, and an output layer. The term “Multiplayer Perceptron” is used herein as a general term to refer to a category of any fully connected multilayer neural network. FIG. 1 shows an MLP with a single hidden layer. Each of these layers computes and passes on the values to the next layer, which is calculated using: Hᵢ=Σi₌₁ⁿxᵢ*wᵢ+bᵢ. The leftmost layer is the input layer 102, the middle layer is the hidden layer 104, and the rightmost layer is the output layer 106. The hidden layer comprises hidden neurons. All three layers 102, 104, 106 are fully connected in the forward direction and data flows from the input layer 102 towards the output layer 106. It is understood, however, that certain types of NN can have feedforward and feedback mechanisms too. A generalization of the mathematical computations involved in the MLP may be expressed as follows:

$${h}_{i} = {Φ}^{1} ( {\sum }_{j} {w}_{ij} * {x}_{j} + {b}_{i} )$$

$${y}_{i} = {Φ}^{2} ( {\sum }_{j} {w}_{ij} * {h}_{j} + {b}_{i} )$$

where xⱼ denotes the input layer unit, wᵢⱼ denotes the weights, bᵢ denotes the bias, hᵢ denotes the hidden layer unit, yᵢ denotes the output layer, and Φ¹ and Φ² are non-linear activation functions of the MLP network.

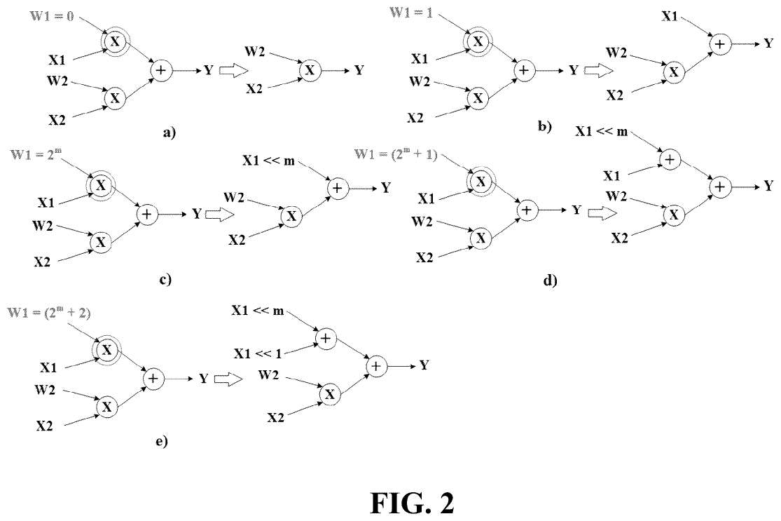

FIG. 2 is a conceptual diagram that illustrates certain aspects of optimization processes, according to some aspects of the present disclosure, for fine-tuning and compressing a NN model based on a simulated annealing algorithm. The simulated annealing algorithm may comprise a global search optimization method inspired by the metallurgical annealing process. It may be used to solved unconstrained and constrained optimization issues. In some examples, the approach may include generating randomized spots in the proximity of the current optimal point and evaluating the problem functions there. In machine learning applications, the algorithm may be used to determine the optimal features during the feature selection procedure by simulating this process. If the value of a cost function is less than its current best values, the point is accepted, and the best function value is adjusted. The point is accepted or refused based on whether or not the function value is greater than the best value found to date.

After the SA algorithm is used to create an optimized and compressed MLP model, an operator strength reduction can be applied and implemented (e.g., using bit shifting) to handle the multiplication operations for multiples of the power of 2 (2^{m}, where m is the indices). Next, the hidden layer neurons are pruned which comprise weights with 0 values, to slim the overall parameters of the MLP. The multiplication operations of all the hidden layer neurons comprising weights with the value of 1 are also reduced. Moreover, the multiplication of the weights are further simplified with values as multiples of (2^{m}+1) and (2^{m}+2) using operator strength reduction and addition operations.

### Example Optimization Algorithm

Algorithm 1, described below, depicts a proposed SA algorithm-based MLP optimization method according to some embodiments. First, a training dataset, D, is prepared, along with a pre-trained single-layered MLP model with weights, W, and biases, B. As an example, the pre-trained MLP model may include parameters in IEEE-754 single-precision FP32 format, but the utility of the optimization methods disclosed herein can be applicable to any MLP. The SA algorithm's various parameters may be subsequently initialized. In some examples, a random solution may be chosen as a starting point, along with the starting annealing temperature Tᵢₙᵢₜ, and the temperature reduction function, α. Next, a specific percentage of the hidden layer neuron weights, Wₚ may be selected for the perturbation of all the neuron weights of the hidden layer. Wₕ, at random, where Wₚ⊆Wₕ.

Algorithm 1: Proposed Methodology Optimization Process:

| | |
|---|---|
| 1: | Select the initial random solution, starting annealing temperature, and temperature |

reduction function.

| 2: | Select a specific % p of the hidden layer neuron weights, Wₚ at random to perturb all the | |
|---|---|---|
| weights, Wₕ of the hidden layer neurons. | | [symbol] Wₚ ⊆ Wₕ |
| 3: | N ← Number of iterations | |
| 4: | While T > T_{final} do | |
| 5: | for each iteration i in N do | |
| 6: | repeat | |
| 7: | Perturb each neuron weights of the hidden layer random. | [symbol] Wₚ ∝ T |
| 8: | Train the MLP model and generate new hidden layer neuron weights, W′. | |
| 9: | if some of the W′ values are ≈ integer then | |
| 10: | Round them to the proximate integer value. | |
| 11: | Measure the predictive performance. | |
| 12: | if performance criteria are met then | |
| 13: | Accept W' and the solution. | |
| 14: | else | |
| 15: | Calculate acceptance probability, P(acceptance). | |
| 16: | Generate random number, R. | [symbol] R ∈ [0,1] |
| 17: | if R > P(acceptance) then | |
| 18: | Reject W′. | |
| 19: | else | |
| 20: | Accept W′ and the solution. | |
| 21: | end if | |
| 22: | end if | |
| 23: | end if | |
| 24: | until all the datasets from D are selected. | |
| 25: | end for | |
| 26: | Reduce the T. | [symbol] T = α * T |

27: end

The number of iterations, N, may also be specified before running the example SA algorithm. Once the example SA algorithm is run, each neuron's weight of the hidden layer may be perturbed at random in each iteration of the training. The Wₚ may be proportional to the T in the above example methodology. For each iteration, the analysis of the newly generated hidden layer neuron weights may be performed. If some of the W′ are proximate to the integer value, they may be rounded to the nearest neighbor integer.

Next, the predictive performance is calculated in terms of the accuracy of the model. If there is an increase in the predictive performance, the newly generated hidden layer neuron weights, W′, and the solution are accepted. If not, the acceptance probability, P(acceptance) is computed. After calculating the acceptance probability, a random number, R, is generated. If R is greater than P(acceptance), W′ is discarded. Otherwise, W′ and the solution are accepted. The equation of the acceptance probability, P(acceptance) may be given by:

$$P ( acceptance ) = \{ \begin{matrix}exp ( - \frac{Δ C}{T} ) , if Δ C \geq 0 \\ 1 , if Δ C < 0\end{matrix} , \qquad \begin{matrix}( 2 ) \\ ( 3 )\end{matrix}$$

where ΔC is the new cost function minus the old cost function. As the number of iterations increases, the probability of selecting an improved solution increases. Additionally, the larger the ΔC, the lower the acceptance probability. Once the number of iterations reaches the maximum number of iterations, Nₘₐₓ, T is reduced by a factor of α.

### Example Hardware Optimization System

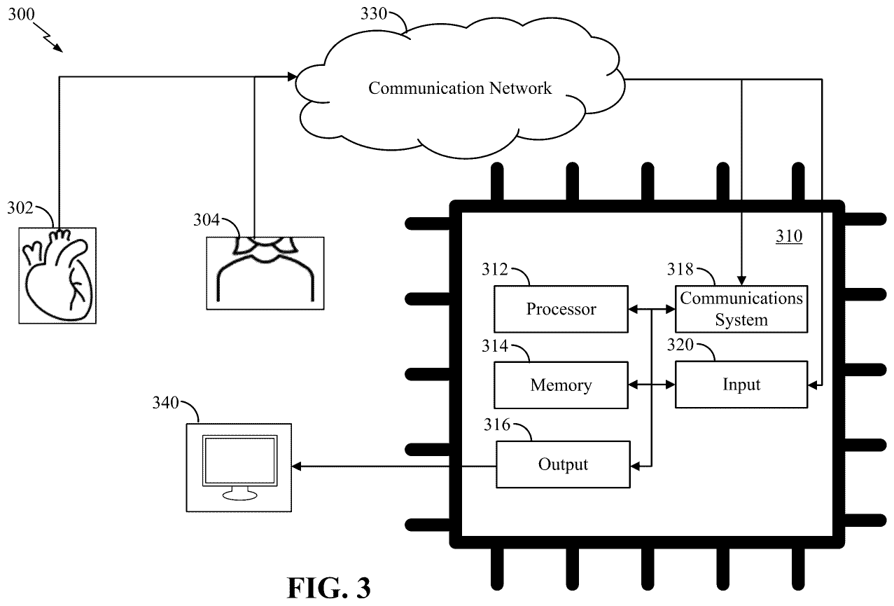

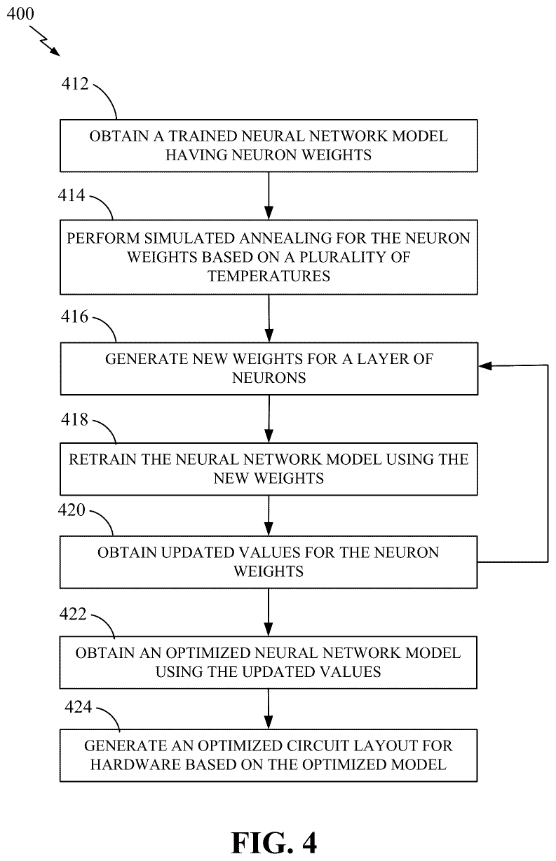

FIG. 3 shows a block diagram illustrating a system 300 for hardware optimization for a neural network model according to some embodiments. In one respect, the process can be thought of as a way to optimize a neural network so that it can more efficiently run on the resources of a given computing device (e.g., a device having a general purpose processor that executes software such as a neural network model). In other respects, the process can be thought of as a way to optimize the layout of a processor/chip in order to more efficiently implement a neural network using fewer resources (for example the chip is more sparse, making it less costly and more energy efficient). As shown, the computing device 310 can be an integrated circuit (IC), a computing chip, or any suitable computing device. In some examples, the computing device 310 can be a special purpose device (e.g, an ASIC) to implement a neural network model. Thus, the process 400 described in FIG. 4 can be implemented for or by a special purpose device.

In the system 300, a computing device 310 can obtain or receive a dataset. As examples (based on experiments conducted) the dataset can be a heart disease dataset 302, a breast cancer dataset 304, an Iris flower dataset, or any other suitable dataset that is amenable to classification or identification tasks. The data sets need not be images, or even data representative of an image. For example, the dataset can include an image, a medical record, X-ray data, magnetic resonance imaging (MRI) data, computed tomography (CT) data, sequences of measurements of equipment function, time series sensor data, or any other suitable data for classification or detection operations that can be performed by an MLP. In other examples, the dataset can include one or more features extracted from input data. Also, in some examples, the dataset can include a training dataset to be used to optimize hardware for a neural network model. In other examples, the dataset can include a runtime dataset for a patient-based task. In some examples, the dataset can be produced by one or more sensors or devices (e.g., X-ray imaging machine, CT machine, MRI machine, a cell phone, or any other suitable devices). In some examples, the dataset can be directly applied to the neural network model. In other examples, one or more features can be extracted from the dataset and be applied to the neural network model. The computing device 310 can receive the dataset, which is stored in a database, via communication network 330 and a communications system 318 or an input 320 of the computing device 310. In some embodiments, it is merely advantageous that the dataset to be used is representative of the type of dataset that a to-be-optimized NN will process during runtime/deployment phase.

The computing device 310 can include an electronic processor 312, a set of input pins (i.e., input 320), a set of output pins, and a specialized layout of circuit gates, which cause the electronic processor 312 to perform a NN operation. Alternatively, the computing device 310 can include a general purpose processor 312 that performs a software-based NN, which is stored in a memory 314. In such embodiments, the processor 312 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

The computing device 310 can further include a memory 314. The memory 314 can include any suitable storage device or memory type that can be used to store suitable data (e.g., the dataset, a trained neural network model, an optimized neural network model, etc.) and instructions that can be used, for example, by the processor 312. The memory 314 can include a non-transitory computer-readable medium including any suitable volatile memory, non-volatile memory, storage, or any suitable combination thereof. For example, memory 314 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 312 can execute at least a portion of process 400 described below in connection with FIG. 4.

The computing device 310 can further include a communications system 318. The communications system 318 can include any suitable hardware, firmware, and/or software for communicating information over the communication network 330 and/or any other suitable communication networks. For example, the communications system 318 can include one or more transceivers, one or more communication chips and/or chip sets, etc. In a more particular example, the communications system 318 can include hardware, firmware and/or software that can be used to establish a Wi-Fi connection, a Bluetooth connection, a cellular connection, an Ethernet connection, etc.

The computing device 310 can receive or transmit information (e.g., dataset 302, 304, a inference output 340, a trained neural network, etc.) and/or any other suitable system over a communication network 330. In some examples, the inference output 340 can include an inference, prediction, or classification. In some examples, the communication network 330 can be any suitable communication network or combination of communication networks. For example, the communication network 330 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 330 can be a local area network, a wide area network, a public network (e.g., the Internet), a private or semi-private network (e.g., a corporate or university intranet), any other suitable type of network, or any suitable combination of networks. Communications links shown in FIG. 3 can each be any suitable communications link or combination of communications links, such as wired links, fiber optic links, Wi-Fi links, Bluetooth links, cellular links, etc.

In some examples, the computing device 310 can further include an output 316. The output 316 can include a set of output pins to output a prediction indication. In other examples, the output 316 can include a display to output a prediction indication. In some embodiments, the display 316 can include any suitable display devices, such as a computer monitor, a touchscreen, a television, an infotainment screen, etc. to display the report, the inference output 340, or any suitable result of an inference output 340. In further examples, the inference output 340 or any other suitable indication can be transmitted to another system or device over the communication network 330. In further examples, the computing device 310 can include an input 320. The input can include a set of input pins to receive the dataset 302, 304. In other examples, the input 320 can include any suitable input devices (e.g., a keyboard, a mouse, a touchscreen, a microphone, etc.) and/or the one or more sensors that can produce the raw sensor data or the dataset 302, 304.

### Example Optimization Process for Neural Network Model

FIG. 4 is a flow diagram illustrating an example process 400 for optimization of a neural network model in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., the computing device 310, the processor 312 with the memory 314, etc.) can be used to perform the example process 400. However, it should be appreciated that any suitable apparatus or means for carrying out the operations or features described below may perform the process 400.

At step 412, the process 400 can obtain a trained neutral network model. In some examples, the trained neural network model includes a plurality of neuron weights. The nodes, or neurons, can be assigned a weight W and a threshold, and after performing the necessary computation, they are forwarded further. The hidden layers may be computationally heavy, and all the neurons are connected to all of the layers in the previous layer and the subsequent layers, to be called fully connected layers. The neural network model may be any of a variety of types of MLPs, and can be trained by any known means. Thus, in some aspects, the process 400 can be implemented in a generalized way for any MLP, and is agnostic of NN type. For example, the process 400 may be implemented with a McCulloch-Pitts type of neuron model.

At step 414, the process 400 performs simulating annealing for the neuron weights based on a plurality of temperatures. In some examples, the starting annealing temperature may be initially kept at 100 degrees. As the simulated annealing algorithm is run, the temperature may decrease by a temperature reduce function, α. For example, the rate at which the annealing temperature, T, decays may be given by T=α*T. The annealing temperature may help predict the probability of acceptance for a given layer of hidden neuron weights. In some examples, a perturbation value is used, which is proportional to the annealing temperature. The perturbation value may be given as a percentage of weight to be removed from neuron. For example, the algorithm may be run using several different perturbation amounts, such as p=5%, 10%, 15%, and 20%, in order to determine a optimal MLP model.

At step 416, the process 400 generates new weights for a layer of neurons in the plurality of neuron weights based on the perturbation value. In some examples, the new weights may be proximate to an integer value, reducing the hardware needed to perform operations of the system. For example, if one or more neuron weights are associated with a multiplication or exponential operation, the new weight(s) may allow the operation to be reduced to a shift operation.

At step 418, the process 400 retrains the neural network model using the new weights. In some examples, training the neural network model using the new weights can allow for the performance criteria of the model to be assessed in terms of accuracy. At step 420, the process 400 obtains updated values for the neuron weights. In some examples, the updated values may be used again at step 416, perturbing another layer of neuron weights. At step 422, the process 400 obtains an optimized neural network model using the updated values. In some examples, the process 400 ends at step 422.

At step 424, the process 400 optionally generates an optimized circuit layout for the hardware, which implements an optimized neural network model generated based on the perturbation of the plurality of neuron weights. For example, the optimized circuit layout can include less circuit gates (e.g., multiplexers, adders, ReLUs, etc.) to implement the optimized neural network model than circuit gates to implement the trained neural network model, whose neuron weights have not been perturbated.

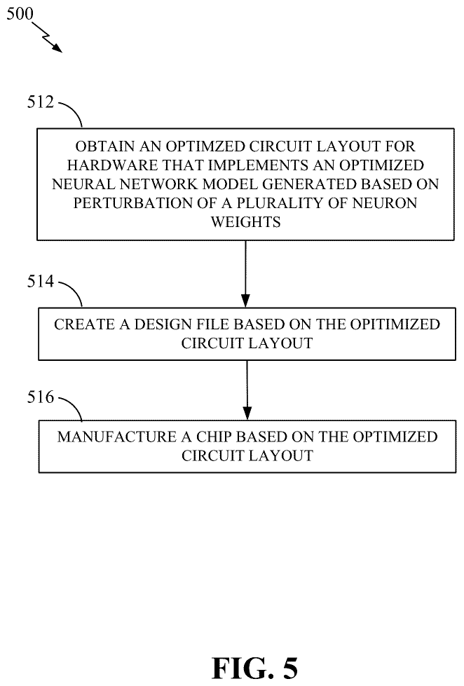

FIG. 5 illustrates a flow diagram of an example process 500 of manufacturing an optimized chip. In some examples, the optimized circuit layout generated by process 400 can be used in step 512 of process 500. At step 514, the process 500 creates a design file based on the optimized circuit layout. For example, the process 500 may input the optimized neural network of FIG. 4 to a standard chip layout optimization software package, resulting in a chip design/layout file. In some examples, chip layout software programs such as Cadence®, Synopsys®, Synthesis®, and other layout generation tools may be used to create chip layout for an optimized neural network. At step 516, the process 500 may include providing the design/layout schematic to a fabrication facility to manufacture a chip based on the optimized circuit layout. The raw materials and resources used by the fabrication facility to make the chip will be reduced as compared to the materials and resources that would have been required to fabricate a chip that implemented the original, non-optimized neural network (e.g, prior to a process of FIG. 4). As described in the examples section below, experiments and modeling of the output of a process such as processes 400 and 500 will result in a determinable reduction in the number of gates (and, correspondingly, the power requirement and cost) needed in a specialized chip to implement the optimized NN as compared to a chip designed to implement the NN prior to optimization as described herein.

### Example SA-Based Optimization Method

In one example, the proposed NN model optimization approach is based on calibrating the hidden layer neuron weights to the closest integer in order to compress the size of the NN model. The subset of hidden layer neuron weights is randomly perturbed as part of the optimization process, with the amount of perturbation (p) being proportional to the annealing temperature (T). At each T, the perturbation of hidden layer neuron weights is performed for N number of iterations. The newly generated weights that are proximate to integers are rounded as a part of the optimization process. The integer weights with a value of 0 are pruned, and the weights with a value of 1 and multiples of 2 are reduced using operator strength reduction such as bit shifting operations. In addition, all of the integer weights are adjusted by resizing the registers to reduce the number of bits to store the weight values. During the SA move, the accuracy of the model is favored while generating new weights. This may help reduce the hardware needed to design an efficient hardware architecture for MLP.

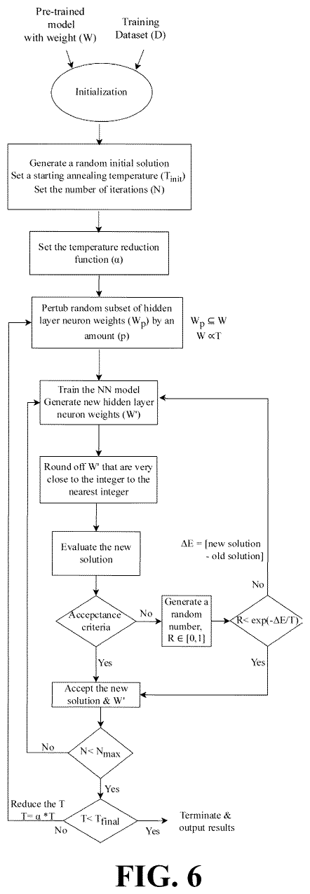

FIG. 6 illustrates a flowchart of an example of an SA-based optimization process. A single precision IEEE-754 FP32 pre-trained MLP model and a training dataset (D) are used as inputs to the proposed method. The customized SA algorithm is initialized by generating an initial solution at random. The starting initial temperature Tᵢₙᵢₜ and the number of iterations N are also specified. The Tᵢₙᵢₜ is kept at 100, and the N varies among 100, 1000, and 10000. The random subset of hidden layer neuron weights Wₚ is perturbed at each temperature T. The amount of perturbation p is kept proportional to the T. The p is set at 10% for this example. Finally, the temperature reduction function, α, is set. The value of a varies among 0.8, 0.9, 0.95, and 0.99 with variation in N for different experiments to seek the optimal solution.

The MLP was trained using a customized SA algorithm. The newly generated weights (W′) that are proximate to the integer are rounded during the optimization process. Each SA move's prediction performance was assessed based on the optimized model's accuracy. If the performance criteria are met, the new solution is accepted along with W′, otherwise, the acceptance probability (P_{acceptance}) is calculated. For the evaluation, a random number, R, is generated, where R∈[0,1]. If (R<P_{acceptance}), the new solution and W′ are accepted. If not, the new weights are discarded and the SA is run again until the model converges to an optimal solution. Following acceptance of the new solution and W′, the SA determines whether or not the maximum number of iterations (Nₘₐₓ) has been reached. If not, it loops back to the iterative process. If Nₘₐₓ is reached, it checks for the final temperature (T_{final}). If T_{final} is not reached, the temperature is reduced using an equation, T=α*T. The T decays with α. And, it loops back to the iterative process to train the NN model. Otherwise, the SA optimization process is terminated with an optimized MLP model as output.

### Experimental Results

This section describes the experimental setup and validates the disclosed methodology. The experiment uses five classification datasets and may include training the classification datasets using contemporary methods by randomly dividing the training and testing data in an 80:20 ratio to generate the MLP model. All the datasets are trained using a single hidden layer MLP. Once the MLP model is generated, the same parameters are used as the pre-trained MLP model, along with the dataset as an input to the custom-modified SA algorithm. After running the SA algorithm for several iterations, the optimized version of the MLP model is obtained.

The hardware MLP model inference architecture is evaluated based on an estimation of the hardware resources utilized by a single unit multiplier and adder circuit architecture. The resource consumption of a single unit of a multiplier and adder is 60 LUTs and 51 LUTs, respectively.

TABLE 1
MLP model configurations.

| Dataset | MLP Configurations | # of Parameters |
|---|---|---|
| Iris | 4-4-3 | 35 |
| Heart Disease | 13-10-2 | 162 |
| Breast Cancer Wisconsin | 30-10-2 | 332 |
| Credit Card Fraud Detection | 29-15-2 | 482 |
| Fetal Health | 21-21-2 | 528 |

The model configuration of a single hidden layered MLP for five different classification datasets is shown in Table 1. The Iris dataset comprises 150 data instances. The MLP configuration for the Iris dataset comprises of 4 input layer units, 4 hidden layer units, and 3 output layer units. The Heart Disease dataset comprises 1025 instances, and its MLLP configuration is 13 input layer units, 10 hidden layer units, and 2 output layer units. The Breast Cancer Wisconsin comprises 569 instances and its MLP configuration is 30 input layer units, 10 hidden layer units, and 2 output layer units. The Credit Card Fraud Detection dataset comprises 284,807 instances, and its MLP configuration is 29 input layer units, 15 hidden layer units, and 2 output layer units. Similarly, the Fetal Health dataset comprises 2,126 instances, and its MLP configuration is 21 input layer units, 21 hidden layer units, and 3 output layer units.

TABLE 2
Optimized MLP model configurations for the best case
solution with p = 10% and N = 10000.

| | | # of | (%) of |
|---|---|---|---|
| | # of | Parameters | Parameters |
| Dataset | Parameters | Rounded to Integers | Rounded |
| Iris | 28 | 7 | 20% |
| Heart Disease | 136 | 26 | 16% |
| Breast Cancer | 271 | 61 | 18% |
| Wisconsin | | | |
| Credit Card Fraud | 370 | 112 | 23% |
| Fetal Health | 417 | 111 | 21% |

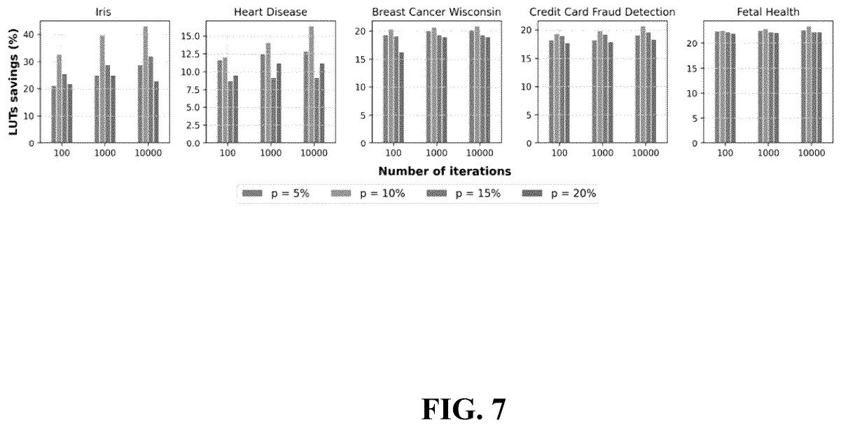

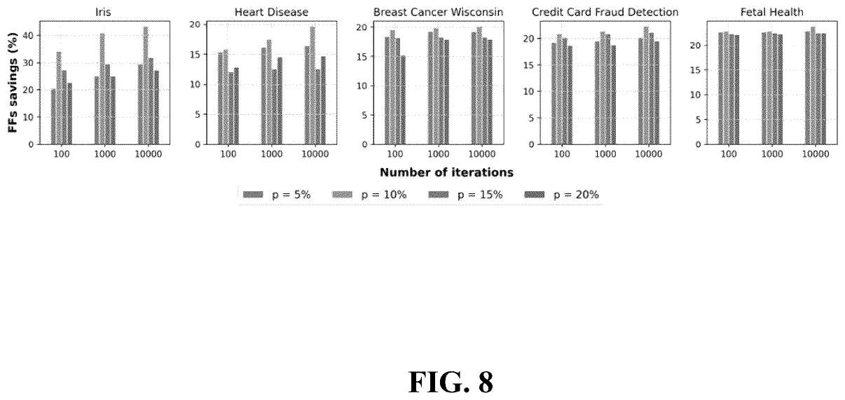

Experiments were conducted to evaluate the efficacy of the proposed methodology by compared the SA-optimized MLP model with the regular MLP mode. The evaluation of the optimized MLP model is based on the reduced number of LUTs and FFs required as compared to the regular MLP model. A total of 12 experiments were performed by making variations in the perturbation amount p of the hidden layer neurons' weight parameter along with the number of iterations N to execute the custom-modified SA algorithm for generating the optimized model that is suitable for resource-constrained environments. The temperature reduction function, a is kept at 0.95 for all the experiments. The perturbation amounts p used in this experiment are 5%, 10%, 15%, and 20%, respectively. For each p, the SA algorithm was executed for 100, 1000, and 10000 iterations, respectively. FIGS. 7 and 8 compare savings (5) in terms of LUTs and FFs between the regular and the SA optimized model with variation in p and N.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A device, comprising:
an electronic processor having:
a set of input pins;
a set of output pins; and
a layout of circuit gates implementing an optimized neural network model, the optimized neural network model obtained by performing a simulated annealing process on a plurality of neuron weights in a trained neural network model; and
wherein the layout causes the electronic processor to:
when receiving a runtime dataset via the set of input pins, extract a plurality of features from the runtime dataset;
apply the plurality of features to the optimized neural network model to obtain a confidence level; and
output a prediction indication based on the confidence level via the output pins.

2. The device of claim 1, wherein the simulated annealing process comprises determining a perturbation value, the perturbation value proportional to a plurality of annealing temperatures.

3. The device of claim 2, wherein the perturbation value is a percentage of weight to be removed from each of the plurality neural weights.

4. The device of claim 3, wherein the simulated annealing process further comprises rounding each of the plurality of neural weights to an integer value.

5. The device of claim 1, wherein the runtime dataset comprises a heart disease dataset, and wherein the confidence level comprises a possibility indication of heart disease in a patient.

6. The device of claim 1, wherein the runtime dataset comprises a breast cancer dataset, and wherein the confidence level comprises a possibility indication of breast cancer in a patient.

7. A method for hardware optimization, comprising:
obtaining a trained neural network model, the trained neural network model comprising a plurality of neurons, the plurality of neurons comprising a plurality of neuron layers and a plurality of neuron weights;
performing a simulated annealing process for the plurality of neuron weights;
generating a plurality of new weights for one of the plurality of neuron layers;
retraining the trained neural network model using the plurality of new weights;
obtaining an updated plurality of neuron weights;
obtaining an optimized neural network model using the updated plurality of neuron weights; and
generating an optimized circuit layout for hardware that implements the optimized neural network model obtained using the updated plurality of neuron weights.

8. The method of claim 7, wherein the simulated annealing process comprises determining a perturbation value, the perturbation value proportional to a plurality of annealing temperatures.

9. The method of claim 7, further comprising providing the optimized circuit layout to a fabrication facility.

10. The method of claim 9, further comprising:
manufacturing a chip according to the optimized circuit layout, wherein the chip has a first number of gates less than a second number of gates for a second chip implementing the trained neural network model.

11. The method of claim 7, wherein the trained neural network model further comprises a feed forward neural network model.

12. The method of claim 11, wherein the trained neural network model further comprises a multilayer perceptron neural network model.

13. The method of claim 5, wherein the trained neural network model comprises an input layer of the plurality of neurons, a hidden layer of the plurality of neurons, and an output layer of the plurality of neurons.

14. A system for hardware optimization, the system comprising:
an electronic processor, and
a non-transitory computer-readable medium storing machine-executable instructions, which, when executed by the electronic processor, cause the electronic processor to:
obtain a trained neural network model comprising a plurality of neurons, the plurality of neurons comprising a plurality of neuron layers and a plurality of neuron weights;
generate a plurality of new weights for one of the plurality of neuron layers;
retrain the trained neural network model using the plurality of new weights;
obtain an optimized neural network model using the updated plurality of neuron weights; and
generate an optimized circuit layout for hardware that implements the optimized neural network model obtained using the updated plurality of neuron weights.

15. The system of claim 14, wherein the simulated annealing process comprises determining a perturbation value, the perturbation value proportional to a plurality of annealing temperatures.

16. The system of claim 15, wherein the perturbation value is a percentage of weight to be removed from each of the plurality of neural weights.

17. The system of claim 16, wherein the simulated annealing process further comprises rounding each of the plurality of neural weights to an integer value.

18. The system of claim 14, wherein the trained neural network model further comprises a feed forward neural network model.

19. The system of claim 18, wherein the trained neural network further comprises a multilayer perceptron neural network model.
